(19) United States
(12) Patent Application Publication
(10) Pub. No.: US 2026/0012857 A1
(43) Pub. Date: Jan. 8, 2026

(54) DEVICES, METHODS, APPARATUSES, AND COMPUTER READABLE MEDIA FOR HANDOVER

(71) Applicant: Nokia Technologies Oy, Espoo (FI)

(72) Inventors: Ping YUAN, Beijing (CN); Mads LAURIDSEN, Gistrup (DK); Jing Yuan SUN, Beijing (CN); Srinivasan SELVAGANAPATHY, Bangalore (IN)

(21) Appl. No.: 18/994,176

(22) PCT Filed: Jul. 25, 2022
(86) PCT No.: PCT/CN2022/107625

§ 371 Date: Jan. 14, 2025

(51) Int. Cl. H04W 36/00; H04W 36/32

(52) U.S. Cl. CPC H04W 36/0058; H04W 36/0064; H04W 36/0088; H04W 36/322

(57) ABSTRACT

Disclosed are devices, methods, apparatuses, and computer readable media for handover. An example terminal device may include at least one processor and at least one memory. The at least one memory may store instructions that, when executed by the at least one processor, may cause the terminal device at least to perform: determining a measurement for at least location information is to be required or unrequired during a handover from a source network device to a target network device; determining a requirement to complete the measurement; and reporting to the source network device, the requirement to complete the measurement in a case where the measurement is determined to be required.

### TECHNICAL FIELD

Various example embodiments relate to devices, methods, apparatuses, and computer readable media for handover.

### BACKGROUND

In a non-terrestrial network (NTN), e.g. internet of things (IOT) NTN, a user equipment (UE) may be expected to determine a “global navigation satellite system (GNSS) validity duration” during which the UE may be able to assume the GNSS position is valid to perform pre-compensation in time and frequency domains for uplink transmissions. In, for example, enhanced machine type communication (eMTC) over NTN, in case of a handover, currently network side is not aware whether a UE will perform GNSS (re)acquisition and how long the UE will take to perform GNSS (re)acquisition before accessing to a target node. If, e.g., the UE has already (re)acquired a GNSS position during radio resource control (RRC) connection before handover, the UE may have no requirement for GNSS measurement, then UE may access to a target base station (BS) without delay caused by a GNSS acquisition. On the other hand, if the UE has to (re)acquire the GNSS position before accessing to the target BS, a time gap between receiving the handover command and accessing to the target BS may be quite large. Therefore, in the network side, since the network side has no knowledge of GNSS measurement requirement during the handover, the network side may not correctly configure a guard timer e.g. T304 described in e.g. 3rd Generation Partnership Project (3GPP) Specification 38.331, which may cause unnecessary handover failure due to, e.g., the configured T304 less than the required GNSS measurement time, moreover, the network side may have to reserve the target BS resources for the UE quite earlier before the UE accesses to the target BS, which will waste the resources in vain. This may happen in both normal handover, e.g., for contention free random access (CFRA), in which the target BS has to reserve the preamble identifier (ID) for the UE, and conditional handover, in which the candidate target BSs have to reserve the dedicated random access channel (RACH) resources for the UE and will waste the RACH resources a lot.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may store instructions that, when executed by the at least one processor, may cause the terminal device at least to perform: determining a measurement for at least location information is to be required or unrequired during a handover from a source network device to a target network device; determining a requirement to complete the measurement; and reporting to the source network device, the requirement to complete the measurement in a case where the measurement is determined to be required.

In some example embodiments, the instructions, when executed by the at least one processor, may cause the terminal device to further perform: reporting to the source network device, the requirement to complete the measurement in a case where the measurement is determined to be unrequired, and the requirement to complete the measurement may indicate that the measurement is to be unrequired.

In some example embodiments, the instructions, when executed by the at least one processor, may cause the terminal device to further perform: refraining from reporting to the source network device, the requirement to complete the measurement in a case where the measurement is determined to be unrequired.

In some example embodiments, the measurement may be determined to be required in a case where a remaining measurement validity duration obtained from a preceding measurement acquisition of the terminal device is less than a threshold.

In some example embodiments, the threshold may be predefined or received from the source network device.

In some example embodiments, the measurement may be based on at least one of the following: a global navigation satellite system, a non-terrestrial network positioning signal, or a terrestrial network positioning signal.

In some example embodiments, the requirement to complete the measurement based on the global navigation satellite system may be determined based on at least one of the following: quality of a global navigation satellite system signal of the terminal device, positioning capability of the terminal device, or availability of ephemeris information of the terminal device for measured global navigation satellite system satellites.

In some example embodiments, the quality of the global navigation satellite system signal may comprise carrier-to-noise of the global navigation satellite system signal.

In some example embodiments, the requirement to complete the measurement may be reported via at least one of the following: a measurement report triggered by a mobility event, a measurement report triggered by the requirement to complete the measurement, an uplink radio resource control message, or an uplink medium access control control element.

In some example embodiments, the instructions, when executed by the at least one processor, may cause the terminal device to further perform: receiving from the source network device, an indication enabling or disabling reporting of the requirement to complete the measurement; and refraining from reporting the requirement to complete the measurement in a case where the indication disables reporting of the requirement to complete the measurement.

In some example embodiments, the requirement to complete the measurement may comprise at least one of following: a time duration for acquiring the measurement, or a time stamp when the terminal device expects to complete the acquisition of the measurement.

In a second aspect, disclosed is a network device. The network device may include at least one processor and at least one memory. The at least one memory may store instructions that, when executed by the at least one processor, may cause the network device as a source network device for a handover of a terminal device at least to perform: receiving from the terminal device, a requirement to complete a measurement for at least location information; and transmitting to a target network device for the handover, a handover request comprising the requirement to complete the measurement.

In some example embodiments, the instructions, when executed by the at least one processor, may cause the network device to further perform: determining a threshold for the terminal device to determine the measurement is to be required in a case where a remaining measurement validity duration obtained from a preceding measurement acquisition is less than the threshold; and transmitting the threshold to the terminal device.

In some example embodiments, the threshold may be determined based on at least one of the following: buffer status of the terminal device, or radio condition of the terminal device.

In some example embodiments, the instructions, when executed by the at least one processor, may cause the network device to further perform: receiving from the target network device, a mapping relationship between a plurality of candidate thresholds and at least one of the following: buffer statuses or radio conditions of a terminal device, and the threshold may be determined from the plurality of candidate thresholds further based on the mapping relationship.

In some example embodiments, the instructions, when executed by the at least one processor, may cause the network device to further perform: receiving from the target network device, a threshold indicated by the target network device, and the threshold for the terminal device may be determined according to the threshold indicated by the target network device.

In some example embodiments, the instructions, when executed by the at least one processor, may cause the network device to further perform: transmitting to the terminal device, an indication enabling or disabling reporting of the requirement to complete the measurement via at least one of the following: a downlink radio resource control message, a system information block, or a downlink medium access control control element.

In some example embodiments, the requirement to complete the measurement may comprise at least one of following: a time duration for the terminal device to acquire the measurement, or a time stamp when the terminal device expects to complete the acquisition of the measurement.

In some example embodiments, the measurement may be based on at least one of the following: a global navigation satellite system, a non-terrestrial network positioning signal, or a terrestrial network positioning signal.

In a third aspect, disclosed is a network device. The network device may include at least one processor and at least one memory. The at least one memory may store instructions that, when executed by the at least one processor, may cause the network device as a target network device for a handover of a terminal device at least to perform: receiving from a source network device for the handover, a handover request comprising a requirement to complete a measurement for at least location information; and determining a value of a guard timer for the handover based on the requirement to complete the measurement.

In some example embodiments, the requirement to complete the measurement may comprise at least one of following: a time duration for the terminal device to acquire the measurement, or a time stamp when the terminal device expects to complete the acquisition of the measurement.

In some example embodiments, the instructions, when executed by the at least one processor, may cause the network device to further perform: reserving resources for the handover of the terminal device, after the time duration timing from receiving the handover request or after the time stamp when the terminal device expects to complete the acquisition of the measurement.

In some example embodiments, the instructions, when executed by the at least one processor, may cause the network device to further perform: determining at least one of the following: a threshold for the terminal device to determine the measurement is to be required in a case where a remaining measurement validity duration obtained from a preceding measurement acquisition is less than the threshold, or a mapping relationship between a plurality of candidate thresholds and at least one of the following: buffer statuses or radio conditions of a terminal device; and transmitting to the source network device, at least one of the following: the threshold or the mapping relationship.

In some example embodiments, the measurement may be based on at least one of the following: a global navigation satellite system, a non-terrestrial network positioning signal, or a terrestrial network positioning signal.

In a fourth aspect, disclosed is a method performed by a terminal device. The method may comprise: determining a measurement for at least location information is to be required or unrequired during a handover from a source network device to a target network device; determining a requirement to complete the measurement; and reporting to the source network device, the requirement to complete the measurement in a case where the measurement is determined to be required.

In some example embodiments, the method may further comprise: reporting to the source network device, the requirement to complete the measurement in a case where the measurement is determined to be unrequired, wherein the requirement to complete the measurement may indicate that the measurement is to be unrequired.

In some example embodiments, the method may further comprise: refraining from reporting to the source network device, the requirement to complete the measurement in a case where the measurement is determined to be unrequired.

In some example embodiments, the measurement may be determined to be required in a case where a remaining measurement validity duration obtained from a preceding measurement acquisition of the terminal device is less than a threshold.

In some example embodiments, the threshold may be predefined or received from the source network device.

In some example embodiments, the measurement may be based on at least one of the following: a global navigation satellite system, a non-terrestrial network positioning signal, or a terrestrial network positioning signal.

In some example embodiments, the requirement to complete the measurement based on the global navigation satellite system may be determined based on at least one of the following: quality of a global navigation satellite system signal of the terminal device, positioning capability of the terminal device, or availability of ephemeris information of the terminal device for measured global navigation satellite system satellites.

In some example embodiments, the quality of the global navigation satellite system signal may comprise carrier-to-noise of the global navigation satellite system signal.

In some example embodiments, the requirement to complete the measurement may be reported via at least one of the following: a measurement report triggered by a mobility event, a measurement report triggered by the requirement to complete the measurement, an uplink radio resource control message, or an uplink medium access control control element.

In some example embodiments, the method may further comprise: receiving from the source network device, an indication enabling or disabling reporting of the requirement to complete the measurement; and refraining from reporting the requirement to complete the measurement in a case where the indication disables reporting of the requirement to complete the measurement.

In some example embodiments, the requirement to complete the measurement may comprise at least one of following: a time duration for acquiring the measurement, or a time stamp when the terminal device expects to complete the acquisition of the measurement.

In a fifth aspect, disclosed is a method performed by a source network device for a handover of a terminal device. The method may comprise: receiving from the terminal device, a requirement to complete a measurement; and transmitting to a target network device for the handover, a handover request comprising the requirement to complete the measurement.

In some example embodiments, the method may further comprise: determining a threshold for the terminal device to determine the measurement is to be required in a case where a remaining measurement validity duration obtained from a preceding measurement acquisition is less than the threshold; and transmitting the threshold to the terminal device.

In some example embodiments, the threshold may be determined based on at least one of the following: buffer status of the terminal device, or radio condition of the terminal device.

In some example embodiments, the method may further comprise: receiving from the target network device, a mapping relationship between a plurality of candidate thresholds and at least one of the following: buffer statuses or radio conditions of a terminal device, wherein the threshold may be determined from the plurality of candidate thresholds further based on the mapping relationship.

In some example embodiments, the method may further comprise: receiving from the target network device, a threshold indicated by the target network device, wherein the threshold for the terminal device may be determined according to the threshold indicated by the target network device.

In some example embodiments, the method may further comprise: transmitting to the terminal device, an indication enabling or disabling reporting of the requirement to complete the measurement via at least one of the following: a downlink radio resource control message, a system information block, or a downlink medium access control control element.

In some example embodiments, the requirement to complete the measurement may comprise at least one of following: a time duration for the terminal device to acquire the measurement, or a time stamp when the terminal device expects to complete the acquisition of the measurement.

In some example embodiments, the measurement may be based on at least one of the following: a global navigation satellite system, a non-terrestrial network positioning signal, or a terrestrial network positioning signal.

In a sixth aspect, disclosed is a method performed by a target network device for a handover of a terminal device. The method may comprise: receiving from a source network device for the handover, a handover request comprising a requirement to complete a measurement for at least location information; and determining a value of a guard timer for the handover based on the requirement to complete the measurement.

In some example embodiments, the requirement to complete the measurement may comprise at least one of following: a time duration for the terminal device to acquire the measurement, or a time stamp when the terminal device expects to complete the acquisition of the measurement.

In some example embodiments, the method may further comprise: reserving resources for the handover of the terminal device, after the time duration timing from receiving the handover request or after the time stamp when the terminal device expects to complete the acquisition of the measurement.

In some example embodiments, the method may further comprise: determining at least one of the following: a threshold for the terminal device to determine the measurement is to be required in a case where a remaining measurement validity duration obtained from a preceding measurement acquisition is less than the threshold, or a mapping relationship between a plurality of candidate thresholds and at least one of the following: buffer statuses or radio conditions of a terminal device; and transmitting to the source network device, at least one of the following: the threshold or the mapping relationship.

In some example embodiments, the measurement may be based on at least one of the following: a global navigation satellite system, a non-terrestrial network positioning signal, or a terrestrial network positioning signal.

In a seventh aspect, disclosed is an apparatus. The apparatus as a terminal device may comprise: means for determining a measurement for at least location information is to be required or unrequired during a handover from a source network device to a target network device; means for determining a requirement to complete the measurement; and means for reporting to the source network device, the requirement to complete the measurement in a case where the measurement is determined to be required.

In some example embodiments, the apparatus may further comprise: means for reporting to the source network device, the requirement to complete the measurement in a case where the measurement is determined to be unrequired, wherein the requirement to complete the measurement may indicate that the measurement is to be unrequired.

In some example embodiments, the apparatus may further comprise: means for refraining from reporting to the source network device, the requirement to complete the measurement in a case where the measurement is determined to be unrequired.

In some example embodiments, the measurement may be determined to be required in a case where a remaining measurement validity duration obtained from a preceding measurement acquisition of the terminal device is less than a threshold.

In some example embodiments, the threshold may be predefined or received from the source network device.

In some example embodiments, the measurement may be based on at least one of the following: a global navigation satellite system, a non-terrestrial network positioning signal, or a terrestrial network positioning signal.

In some example embodiments, the requirement to complete the measurement based on the global navigation satellite system may be determined based on at least one of the following: quality of a global navigation satellite system signal of the terminal device, positioning capability of the terminal device, or availability of ephemeris information of the terminal device for measured global navigation satellite system satellites.

In some example embodiments, the quality of the global navigation satellite system signal may comprise carrier-to-noise of the global navigation satellite system signal.

In some example embodiments, the requirement to complete the measurement may be reported via at least one of the following: a measurement report triggered by a mobility event, a measurement report triggered by the requirement to complete the measurement, an uplink radio resource control message, or an uplink medium access control control element.

In some example embodiments, the apparatus may further comprise: means for receiving from the source network device, an indication enabling or disabling reporting of the requirement to complete the measurement; and means for refraining from reporting the requirement to complete the measurement in a case where the indication disables reporting of the requirement to complete the measurement.

In some example embodiments, the requirement to complete the measurement may comprise at least one of following: a time duration for acquiring the measurement, or a time stamp when the terminal device expects to complete the acquisition of the measurement.

In an eighth aspect, disclosed is an apparatus. The apparatus as a source network device for a handover of a terminal device may comprise: means for receiving from the terminal device, a requirement to complete a measurement for at least location information; and means for transmitting to a target network device for the handover, a handover request comprising the requirement to complete the measurement.

In some example embodiments, the apparatus may further comprise: means for determining a threshold for the terminal device to determine the measurement is to be required in a case where a remaining validity duration obtained from a preceding acquisition is less than the threshold; and means for transmitting the threshold to the terminal device.

In some example embodiments, the threshold may be determined based on at least one of the following: buffer status of the terminal device, or radio condition of the terminal device.

In some example embodiments, the apparatus may further comprise: means for receiving from the target network device, a mapping relationship between a plurality of candidate thresholds and at least one of the following: buffer statuses or radio conditions of a terminal device, wherein the threshold may be determined from the plurality of candidate thresholds further based on the mapping relationship.

In some example embodiments, the apparatus may further comprise: means for receiving from the target network device, a threshold indicated by the target network device, wherein the threshold for the terminal device may be determined according to the threshold indicated by the target network device.

In some example embodiments, the apparatus may further comprise: means for transmitting to the terminal device, an indication enabling or disabling reporting of the requirement to complete the measurement via at least one of the following: a downlink radio resource control message, a system information block, or a downlink medium access control control element.

In some example embodiments, the requirement to complete the measurement may comprise at least one of following: a time duration for the terminal device to acquire the measurement, or a time stamp when the terminal device expects to complete the acquisition of the measurement.

In some example embodiments, the measurement may be based on at least one of the following: a global navigation satellite system, a non-terrestrial network positioning signal, or a terrestrial network positioning signal.

In a ninth aspect, disclosed is an apparatus. The apparatus as a target network device for a handover of a terminal device may comprise: means for receiving from a source network device for the handover, a handover request comprising a requirement to complete a measurement for at least location information; and means for determining a value of a guard timer for the handover based on the requirement to complete the measurement.

In some example embodiments, the requirement to complete the measurement may comprise at least one of following: a time duration for the terminal device to acquire the measurement, or a time stamp when the terminal device expects to complete the acquisition of the measurement.

In some example embodiments, the apparatus may further comprise: means for reserving resources for the handover of the terminal device, after the time duration timing from receiving the handover request or after the time stamp when the terminal device expects to complete the acquisition of the measurement.

In some example embodiments, the apparatus may further comprise: means for determining at least one of the following: a threshold for the terminal device to determine the measurement is to be required in a case where a remaining measurement validity duration obtained from a preceding measurement acquisition is less than the threshold, or a mapping relationship between a plurality of candidate thresholds and at least one of the following: buffer statuses or radio conditions of a terminal device; and means for transmitting to the source network device, at least one of the following: the threshold or the mapping relationship.

In some example embodiments, the measurement may be based on at least one of the following: a global navigation satellite system, a non-terrestrial network positioning signal, or a terrestrial network positioning signal.

In a tenth aspect, a computer readable medium is disclosed. The computer readable medium may comprise program instructions that, when executed by a terminal device, may cause the terminal device at least to perform: determining a measurement for at least location information is to be required or unrequired during a handover from a source network device to a target network device; determining a requirement to complete the measurement; and reporting to the source network device, the requirement to complete the measurement in a case where the measurement is determined to be required.

In some example embodiments, the computer readable medium may further comprise instructions that, when executed by the terminal device, may cause the terminal device to further perform: reporting to the source network device, the requirement to complete the measurement in a case where the measurement is determined to be unrequired, wherein the requirement to complete the measurement may indicate that the measurement is to be unrequired.

In some example embodiments, the computer readable medium may further comprise instructions that, when executed by the terminal device, may cause the terminal device to further perform: refraining from reporting to the source network device, the requirement to complete the measurement in a case where the measurement is determined to be unrequired.

In some example embodiments, the measurement may be determined to be required in a case where a remaining measurement validity duration obtained from a preceding measurement acquisition of the terminal device is less than a threshold.

In some example embodiments, the threshold may be predefined or received from the source network device.

In some example embodiments, the measurement may be based on at least one of the following: a global navigation satellite system, a non-terrestrial network positioning signal, or a terrestrial network positioning signal.

In some example embodiments, the requirement to complete the measurement based on the global navigation satellite system may be determined based on at least one of the following: quality of a global navigation satellite system signal of the terminal device, positioning capability of the terminal device, or availability of ephemeris information of the terminal device for measured global navigation satellite system satellites.

In some example embodiments, the quality of the global navigation satellite system signal may comprise carrier-to-noise of the global navigation satellite system signal.

In some example embodiments, the requirement to complete the measurement may be reported via at least one of the following: a measurement report triggered by a mobility event, a measurement report triggered by the requirement to complete the measurement, an uplink radio resource control message, or an uplink medium access control control element.

In some example embodiments, the computer readable medium may further comprise instructions that, when executed by the terminal device, may cause the terminal device to further perform: receiving from the source network device, an indication enabling or disabling reporting of the requirement to complete the measurement; and refraining from reporting the requirement to complete the measurement in a case where the indication disables reporting of the requirement to complete the measurement.

In some example embodiments, the requirement to complete the measurement may comprise at least one of following: a time duration for acquiring the measurement, or a time stamp when the terminal device expects to complete the acquisition of the measurement.

In an eleventh aspect, a computer readable medium is disclosed. The computer readable medium may comprise program instructions that, when executed by a network device as a source network device for a handover of a terminal device, cause the network device at least to perform: receiving from the terminal device, a requirement to complete a measurement for at least location information; and transmitting to a target network device for the handover, a handover request comprising the requirement to complete the measurement.

In some example embodiments, the computer readable medium may further comprise instructions that, when executed by the network device, may cause the network device to further perform: determining a threshold for the terminal device to determine the measurement is to be required in a case where a remaining measurement validity duration obtained from a preceding measurement acquisition is less than the threshold; and transmitting the threshold to the terminal device.

In some example embodiments, the threshold may be determined based on at least one of the following: buffer status of the terminal device, or radio condition of the terminal device.

In some example embodiments, the computer readable medium may further comprise instructions that, when executed by the network device, may cause the network device to further perform: receiving from the target network device, a mapping relationship between a plurality of candidate thresholds and at least one of the following: buffer statuses or radio conditions of a terminal device, wherein the threshold may be determined from the plurality of candidate thresholds further based on the mapping relationship.

In some example embodiments, the computer readable medium may further comprise instructions that, when executed by the network device, may cause the network device to further perform: receiving from the target network device, a threshold indicated by the target network device, wherein the threshold for the terminal device may be determined according to the threshold indicated by the target network device.

In some example embodiments, the computer readable medium may further comprise instructions that, when executed by the network device, may cause the network device to further perform: transmitting to the terminal device, an indication enabling or disabling reporting of the requirement to complete the measurement via at least one of the following: a downlink radio resource control message, a system information block, or a downlink medium access control control element.

In some example embodiments, the requirement to complete the measurement may comprise at least one of following: a time duration for the terminal device to acquire the measurement, or a time stamp when the terminal device expects to complete the acquisition of the measurement.

In some example embodiments, the measurement may be based on at least one of the following: a global navigation satellite system, a non-terrestrial network positioning signal, or a terrestrial network positioning signal.

In a twelfth aspect, a computer readable medium is disclosed. The computer readable medium may comprise program instructions that, when executed by a network device as a target network device for a handover of a terminal device, cause the network device at least to perform: receiving from a source network device for the handover, a handover request comprising a requirement to complete a measurement for at least location information; and determining a value of a guard timer for the handover based on the requirement to complete the measurement.

In some example embodiments, the requirement to complete the measurement may comprise at least one of following: a time duration for the terminal device to acquire the measurement, or a time stamp when the terminal device expects to complete the acquisition of the measurement.

In some example embodiments, the computer readable medium may further comprise instructions that, when executed by the network device, may cause the network device to further perform: reserving resources for the handover of the terminal device, after the time duration timing from receiving the handover request or after the time stamp when the terminal device expects to complete the acquisition of the measurement.

In some example embodiments, the computer readable medium may further comprise instructions that, when executed by the network device, may cause the network device to further perform: determining at least one of the following: a threshold for the terminal device to determine the measurement is to be required in a case where a remaining measurement validity duration obtained from a preceding measurement acquisition is less than the threshold, or a mapping relationship between a plurality of candidate thresholds and at least one of the following: buffer statuses or radio conditions of a terminal device; and transmitting to the source network device, at least one of the following: the threshold or the mapping relationship.

Other features and advantages of the example embodiments of the present disclosure will also be apparent from the following description of specific embodiments when read in conjunction with the accompanying drawings, which illustrate, by way of example, the principles of example embodiments of the present disclosure.

In some example embodiments, the measurement may be based on at least one of the following: a global navigation satellite system, a non-terrestrial network positioning signal, or a terrestrial network positioning signal.

### BRIEF DESCRIPTION OF THE DRAWINGS

Some example embodiments will now be described, by way of non-limiting examples, with reference to the accompanying drawings.

FIG. 1 shows an exemplary sequence diagram for handover according to the example embodiments of the present disclosure.

FIG. 2 shows a flow chart illustrating an example method 200 for handover according to the example embodiments of the present disclosure.

FIG. 3 shows a flow chart illustrating an example method 300 for handover according to the example embodiments of the present disclosure.

FIG. 4 shows a flow chart illustrating an example method 400 for handover according to the example embodiments of the present disclosure.

FIG. 5 shows a block diagram illustrating an example device 500 for handover according to the example embodiments of the present disclosure.

FIG. 6 shows a block diagram illustrating an example device 600 for handover according to the example embodiments of the present disclosure.

FIG. 7 shows a block diagram illustrating an example device 700 for handover according to the example embodiments of the present disclosure.

FIG. 8 shows a block diagram illustrating an example apparatus 800 for handover according to the example embodiments of the present disclosure.

FIG. 9 shows a block diagram illustrating an example apparatus 900 for handover according to the example embodiments of the present disclosure.

FIG. 10 shows a block diagram illustrating an example apparatus 1000 for handover according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for handover in e.g. the eMTC over NTN. According to the example embodiments of the present disclosure, the handover solution may not only facilitate the network side to configure a proper guard timer e.g. T304 for handover but also enable the handover to be performed in a resource efficient way.

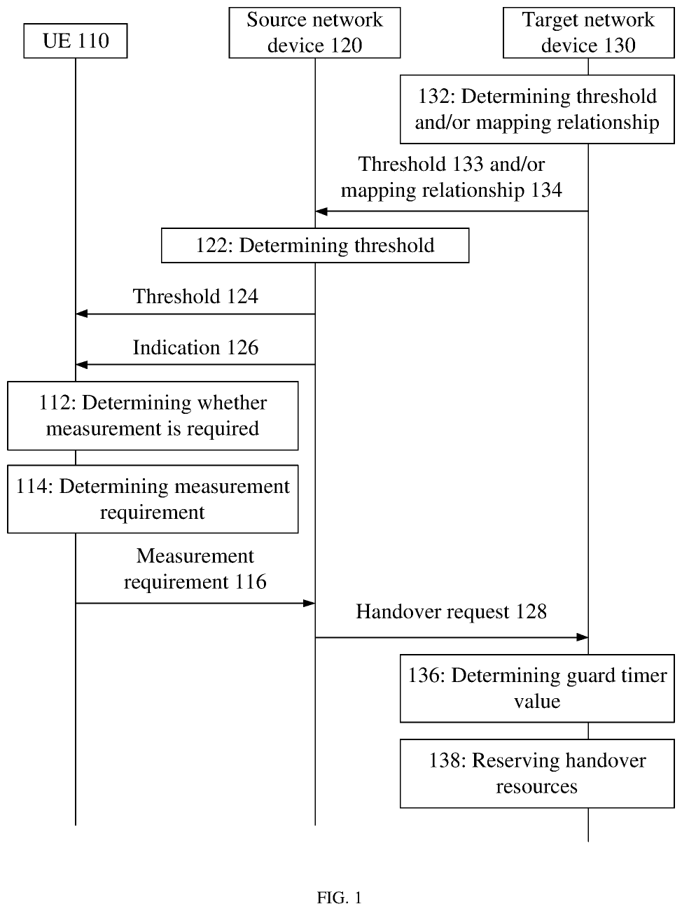

FIG. 1 shows an exemplary sequence diagram for handover according to the example embodiments of the present disclosure. Referring to the FIG. 1, a UE 110 may represent any terminal device in a NTN. A source network device 120 may function as a base station (BS) in the NTN and currently serving the UE 110 as a source node of a handover. A target network device 130 may function as another BS in the NTN and may serve the UE 110 as a target node of the handover. The handover may be a normal handover such as for CFRA, etc. and may also be a conditional handover, for which the target network device 130 may serve as any candidate target node.

In an operation 112, the UE 110 may determine a measurement for at least location information is to be required or unrequired during a handover from the source network device 120 to the target network device 130. In an embodiment, the UE 110 may compare a remaining measurement validity duration obtained from a preceding measurement acquisition of the UE 110 with a threshold and determine the measurement is to be required in a case where the remaining measurement validity duration obtained from the preceding measurement acquisition is less than the threshold. In the example embodiments, the remaining measurement validity duration may refer to the remaining duration the preceding measurement result obtained from the preceding measurement acquisition may be valid. For example, the remaining GNSS validity duration may be the remaining duration the preceding GNSS measurement result may be valid.

Assuming that the measurement validity duration obtained from a preceding measurement acquisition is d1, and from the preceding measurement acquisition a time duration d2 has passed, then the remaining measurement validity duration obtained from the preceding measurement acquisition is a value of (d1-d2). If the remaining measurement validity duration obtained from the preceding measurement acquisition is longer than the threshold, generally the remaining measurement validity duration may guarantee the UE 110 to access to the target network device 130, and thus the measurement will be unrequired.

In the example embodiments, the measurement may be based on at least one of the following: a GNSS, a NTN positioning signal, or a terrestrial network (TN) positioning signal. In an embodiment, the measurement may be based on the GNSS, such as global positioning system (GPS), Galileo satellite navigation system, Beidou navigation satellite system, etc. In this case, the measurement based on the GNSS may provide both UE location information and accurate time. Alternatively or additionally, the measurement for the location information may be based on the NTN positioning signal, or the TN positioning signal.

It may be appreciated that in the present disclosure the terms “acquisition” and “reacquisition” with respect to the measurement for at least the location information refer to the same or substantially identical meaning and would not result in substantially different outcomes, and in the present disclosure the term “acquisition” is used and may also refer to the situation of term “reacquisition.”

The threshold may be predefined or received from the source network device 120, e.g. the threshold 124 shown in the FIG. 1. In an embodiment, the threshold may be predefined in a specification or a standard, such that the threshold may be predefined in the UE 110.

Alternatively or additionally, in an operation 122, the source network device 120 may determine the threshold 124 and transmit the threshold 124 to the UE 110. In an embodiment, the source network device 120 may determine the threshold 124 based on at least one of the following: buffer status of the UE 110, or radio condition of the UE 110. For example, taking the buffer status and/or the radio condition of the UE 110 into account, the source network device 120 may estimate how long the UE 110 may complete transmission of data in the buffer, i.e. empty the buffer, and determine the threshold 124 accordingly, such that the UE 110 may determine whether the data transmission can be completed within the current measurement validity duration.

Alternatively or additionally, in an operation 132, the target network device 130 may determine a threshold 133. In an embodiment, the target network device 130 may determine the threshold 133 based on the estimation on how long the UE 110 can access to the target network device 130. Then, the target network device 130 may transmit the threshold 133 to the source network device 120, and the source network device 120 may determine the threshold 133 indicated by target network device as the threshold 124 and transmit the threshold 124 to the UE 110.

Alternatively or additionally, in the operation 132, the target network device 130 may determine a mapping relationship 134 between a plurality of candidate thresholds and buffer statuses and/or radio conditions of a UE. For example, the target network device 130 may estimate, based on different buffer statuses and/or radio conditions of a UE, how long the UE may complete the data transmission in the buffer and determine a plurality of candidate thresholds accordingly. Thus the target network device 130 may determine the mapping relationship 134 between the plurality of candidate thresholds and the buffer statuses and/or the radio conditions. Then, the target network device 130 may transmit the mapping relationship 134 to the source network device 120. The mapping relationship 134 may be transmitted via e.g. an inter-node message in X2 configuration setup procedure, where X2 is an interface between BSs.

The plurality of candidate thresholds may be used for the source network device 120 to determine the threshold 124 based on at least one of the following: the buffer status of the UE 110, or the radio condition of the UE 110. The mapping relationship 134 may be of a type of a mapping table. Based on the mapping relationship 134, for example, by checking the mapping table, the source network device 120 may determine the threshold 124 from the plurality of candidate thresholds corresponding to the buffer status and/or the radio condition of the UE 110.

On the UE side, in an operation 114, the UE 110 may determine a requirement 116 to complete the measurement. In an embodiment, the requirement 116 to complete the measurement may comprise a time duration for acquiring the measurement. For example, if the measurement is based on the GNSS, the UE 110 may determine the requirement 116 to complete the measurement based on at least one of the following: quality of a GNSS signal of the UE 110, positioning capability of the UE 110, or availability of ephemeris information of the UE 110 for measured GNSS satellites.

The quality of the GNSS signal may comprise, for example, carrier-to-noise of the GNSS signal. Location environment, e.g. different noise levels or different environment on reflection/multi-path and shadowing, etc. may impact the carrier-to-noise. For example, if the UE 110 is an indoor UE, the carrier-to-noise of the GNSS signal may probably low, and thus the time duration for acquiring the GNSS measurement may be long. If the UE 110 is in an open and spacious area, the carrier-to-noise of the GNSS signal may probably high, and thus the time duration for acquiring the GNSS measurement may be short.

Moreover, for example, if the UE 110 has less receiving antenna, e.g. one receiving antenna, the positioning capability of the UE 110 may be weak, thus the time duration for acquiring the GNSS measurement may be long. If the UE 110 has more receiving antennas, e.g. two or more receiving antennas, the positioning capability of the UE 110 may be strong, thus the time duration for acquiring the GNSS measurement may be short. In addition, different chips may also result in different positioning capabilities.

Moreover, if the UE 110 is to perform warm start, where the UE 110 is expected to have almanac but without ephemeris information, the UE 110 needs to first obtain the ephemeris information and thus the time duration for acquiring the GNSS measurement may be long. If the UE 110 is to perform hot start, where the UE 110 is expected to have both almanac and ephemeris information, the UE 110 may rapidly acquire the GNSS signal for positioning, and thus the time duration for acquiring the GNSS measurement may be short.

Alternatively or additionally, the requirement 116 to complete the measurement may comprise a time stamp when the UE 110 expects to complete the acquisition of the measurement. Taking the measurement based on the GNSS as an example, based on at least one of the following: quality of a GNSS signal of the UE 110, positioning capability of the UE 110, or availability of ephemeris information of the UE 110 for measured GNSS satellites, similar to the estimation of the time duration for acquiring the GNSS measurement, the UE 110 may estimate when the acquisition of the GNSS measurement may expect to be completed and determine the time stamp accordingly.

Then, the UE 110 may report to the source network device 120, the requirement 116 to complete the measurement. In an embodiment, the reporting of the requirement 116 may be performed in a case where the measurement is determined to be required in the operation 112. As an option, in a case where in the operation 112 the UE 110 determines the measurement is to be unrequired, the requirement 116 to complete the measurement may comprise a time value, e.g., zero to indicate that the measurement is to be unrequired. Thus, the UE 110 may report to the source network device 120, the requirement 116 to complete the measurement in a case where the measurement is determined to be unrequired in the operation 112. In this case, the requirement 116 to complete the measurement may indicate that the measurement is to be unrequired.

Alternatively, the UE 110 may refrain from reporting to the source network device 120, the requirement 116 to complete the measurement in a case where the measurement is determined to be unrequired in the operation 112. Thus, the uplink signaling overhead may be saved.

In an embodiment, the requirement 116 to complete the measurement may be reported via at least one of the following: a measurement report triggered by a mobility event, a measurement report triggered by the requirement 116 to complete the measurement, an uplink RRC message, or an uplink medium access control control element (MAC CE). The mobility event may be for example A3 and/or A5 events described in e.g. 3GPP Specification 38.331. If A3 and/or A5 events trigger a measurement report, the UE 110 may incorporate the requirement 116 into the measurement report triggered by A3 and/or A5 events and transmit the measurement report to the source network device 120. Alternatively or additionally, the requirement 116 to complete the measurement itself may also trigger a measurement report, and the UE 110 may incorporate the requirement 116 into the measurement report triggered by the requirement 116 itself and transmit the measurement report to the source network device 120. Alternatively or additionally, the requirement 116 to complete the measurement may trigger an uplink RRC message e.g. additional uplink assistance information, and the UE 110 may transmit the uplink RRC message comprising the requirement 116 to the source network device 120. Alternatively or additionally, the UE 110 may transmit the requirement 116 to the source network device 120 via an uplink MAC CE.

In an embodiment, as an option, the network side may configure whether or not to enable reporting of the requirement 116 to complete the measurement. For example, either the source network device 120 or the target network device 130, or both may assume that the UE 110 will perform the measurement for a relatively long period during the handover, and thus the target network device 130 may configure a guard timer e.g. T304 long enough for the handover. In this case either the source network device 120 or the target network device 130, or both may disable reporting of the requirement 116 such that the uplink transmission overhead may be saved.

For example, the source network device 120 may transmit to the UE 110, an indication 126 enabling or disabling reporting of the requirement 116 to complete the measurement. The indication 126 may be e.g. included in a configuration for measurement transmitted from the source network device 120 to the UE 110. In an embodiment, the indication 126 may be transmitted via at least one of the following: a downlink RRC message, a system information block (SIB), or a downlink MAC CE. For example, the indication 126 may be transmitted in a RRC connection reconfiguration for mobility control or assistance information reporting.

Receiving the indication 126 from the source network device 120, the UE 110 may refrain from reporting the requirement 116 to complete the measurement in a case where the indication 126 disables reporting of the requirement 116 to complete the measurement. It may be appreciated that afterwards the UE 110 may resume to report the requirement 116 if receiving the indication 126 enabling reporting of the requirement 116.

Receiving from the UE 110, the requirement 116 to complete the measurement, the source network device 120 may make a handover decision for the UE 110. For example, the source network device 120 may decode the measurement report, the uplink RRC message, or the uplink MAC CE carrying the requirement 116 to complete the measurement to get the requirement 116. Then, the source network device 120 may transmit to the target network device 130 for the handover, a handover request 128 comprising the requirement 116 to complete the measurement. For example, the handover request 128 may be transmitted via e.g. an inter-node message.

Receiving the handover request 128, in an operation 136, the target network device 130 may determine a value of the guard timer, e.g. the T304, for the handover based on the requirement 116 to complete the measurement. The value of the guard timer may be determined to be larger than the requirement 116 to complete the measurement, such that the UE 110 may complete the measurement before the guard timer expires. Thus, the solution according to the embodiments of the present disclosure may enable the network side to configure the handover guard timer e.g. the T304 properly, which can avoid unexpected handover failure due to measurement time requirements.

In an embodiment, the target network device 130 may estimate a margin for scheduling and message handling, such as the scheduling of handover request acknowledgement (ACK), RRC connection reconfiguration, the UE 110 detaching from the source network device 120 and synchronizing with the target network device 130, etc., and in this case the value of the guard timer may be determined to be larger than the requirement 116 plus the margin.

Before, after, or in parallel to the operation 136, in an operation 138, the target network device 130 may reserve resources for the handover of the UE 110 after the time duration for the UE 110 to acquire the measurement, or after the time stamp when the UE 110 expects to complete the acquisition of the measurement. The time duration in the requirement 116 may be timing from receiving the handover request 128, i.e. starting upon receiving the handover request 128. The resources for the handover may comprise e.g. the resources for the RACH of the UE 110, or preconfigured uplink resources such as reserved physical uplink shared channel (PUSCH) etc. Thus, the solution according to the embodiments of the present disclosure may enable the network side to reserve the resources at the proper time, which can avoid the waste of the network resources.

Then, the target network device 130 may transmit to the source network device 120 a handover request ACK. Receiving the handover request ACK, the source network device 120 may transmit to the UE 110 a RRC connection reconfiguration message, which may comprise mobility control information. Receiving the RRC connection reconfiguration message, the UE 110 may start the guard timer, e.g. the T304, and may detach from the old cell associated with the source network device 120.

If the measurement is determined to be required in the operation 112, the UE 110 may perform the measurement, and if the measurement is determined to be unrequired in the operation 112, the UE 110 may skip the measurement. Then, the UE 110 may perform synchronization to the new cell associated with the target network device 130. After the synchronization, the target network device 130 may allocate uplink resources for the UE 110 and set timing advance (TA) for the UE 110. With the uplink allocation and the TA, the UE 110 may transmit to the target network device 130, a RRC connection reconfiguration complete message, which may comprise the measurement validity duration of the UE 110. Receiving the RRC connection reconfiguration complete message, the target network device 130 may transmit to the source network device 120, a handover success message.

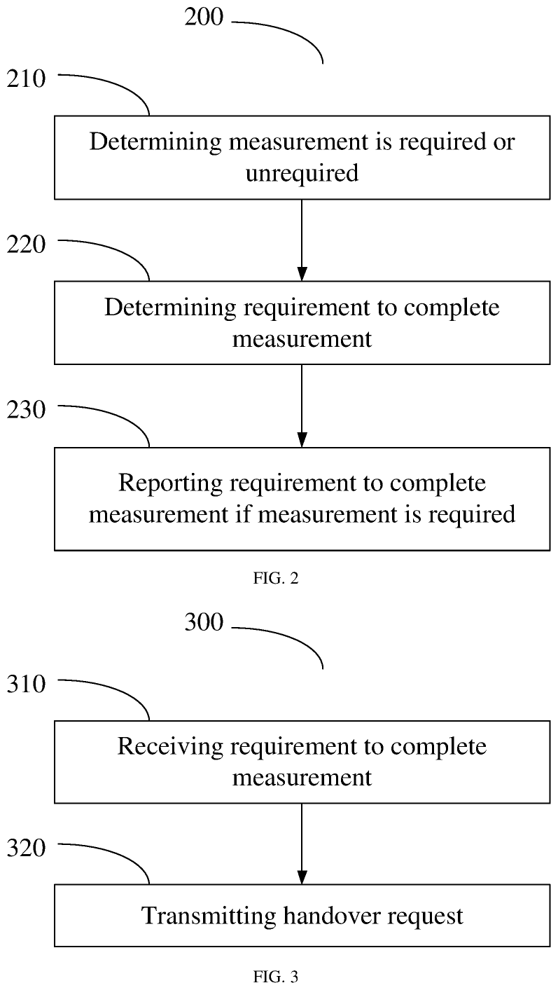

FIG. 2 shows a flow chart illustrating an example method 200 for handover according to the example embodiments of the present disclosure. The example method 200 may be performed for example at a terminal device such as the UE 110.

Referring to the FIG. 2, the example method 200 may include an operation 210 of determining a measurement for at least location information is to be required or unrequired during a handover from a source network device to a target network device; an operation 220 of determining a requirement to complete the measurement; and an operation 230 of reporting to the source network device, the requirement to complete the measurement in a case where the measurement is determined to be required.

Details of the operation 210 have been described in the above descriptions with respect to at least the operation 112, and repetitive descriptions thereof are omitted here.

Details of the operation 220 have been described in the above descriptions with respect to at least the operation 114, and repetitive descriptions thereof are omitted here.

Details of the operation 230 have been described in the above descriptions with respect to at least the requirement 116 to complete the measurement, and repetitive descriptions thereof are omitted here.

In an embodiment, the example method 200 may further include an operation of reporting to the source network device, the requirement to complete the measurement in a case where the measurement is determined to be unrequired, and wherein the requirement to complete the measurement may indicate that the measurement is to be unrequired. The more details have been described in the above descriptions with respect to at least the requirement 116 to complete the measurement, and repetitive descriptions thereof are omitted here.

In an embodiment, the example method 200 may further include an operation of refraining from reporting to the source network device, the requirement to complete the measurement in a case where the measurement is determined to be unrequired. The more details have been described in the above descriptions with respect to at least the requirement 116 to complete the measurement, and repetitive descriptions thereof are omitted here.

In an embodiment, the measurement may be determined to be required in a case where a remaining measurement validity duration obtained from a preceding measurement acquisition of the terminal device is less than a threshold. The more details have been described in the above descriptions with respect to at least the threshold and the operation 112, and repetitive descriptions thereof are omitted here.

In an embodiment, the threshold may be predefined or received from the source network device. The more details have been described in the above descriptions with respect to at least the threshold, and repetitive descriptions thereof are omitted here.

In an embodiment, the measurement may be based on at least one of the following: a GNSS, a NTN positioning signal, or a TN positioning signal. The more details have been described in the above descriptions with respect to at least the operation 112, and repetitive descriptions thereof are omitted here.

In an embodiment, the requirement to complete the measurement based on the GNSS may be determined based on at least one of the following: quality of a GNSS signal of the terminal device, positioning capability of the terminal device, or availability of ephemeris information of the terminal device for measured GNSS satellites. The more details have been described in the above descriptions with respect to at least the requirement 116 to complete the measurement and the operation 114, and repetitive descriptions thereof are omitted here.

In an embodiment, the quality of the GNSS signal comprises carrier-to-noise of the GNSS signal. The more details have been described in the above descriptions with respect to at least the requirement 116 to complete the measurement and the operation 114, and repetitive descriptions thereof are omitted here.

In an embodiment, the requirement to complete the measurement may be reported via at least one of the following: a measurement report triggered by a mobility event, a measurement report triggered by the requirement to complete the measurement, an uplink RRC message, or an uplink MAC CE. The more details have been described in the above descriptions with respect to at least the requirement 116 to complete the measurement, and repetitive descriptions thereof are omitted here.

In an embodiment, the example method 200 may further include an operation of receiving from the source network device, an indication enabling or disabling reporting of the requirement to complete the measurement; and an operation of refraining from reporting the requirement to complete the measurement in a case where the indication disables reporting of the requirement to complete the measurement. The more details have been described in the above descriptions with respect to at least the indication 126, and repetitive descriptions thereof are omitted here.

In an embodiment, the requirement to complete the measurement comprises at least one of following: a time duration for acquiring the measurement, or a time stamp when the terminal device expects to complete the acquisition of the measurement. The more details have been described in the above descriptions with respect to at least the requirement 116 to complete the measurement, and repetitive descriptions thereof are omitted here.

FIG. 3 shows a flow chart illustrating an example method 300 for handover according to the example embodiments of the present disclosure. The example method 300 may be performed for example at a network device such as the source network device 120 for a handover of a terminal device such as the UE 110.

Referring to the FIG. 3, the example method 300 may include an operation 310 of receiving from the terminal device, a requirement to complete a measurement for at least location information; and an operation 320 of transmitting to a target network device for the handover, a handover request comprising the requirement to complete the measurement.

Details of the operation 310 have been described in the above descriptions with respect to at least the requirement 116 to complete the measurement, and repetitive descriptions thereof are omitted here.

Details of the operation 320 have been described in the above descriptions with respect to at least the handover request 128, and repetitive descriptions thereof are omitted here.

In an embodiment, the example method 300 may further include an operation of determining a threshold for the terminal device to determine the measurement is to be required in a case where a remaining measurement validity duration obtained from a preceding measurement acquisition is less than the threshold; and an operation of transmitting the threshold to the terminal device. The more details have been described in the above descriptions with respect to at least the operation 122 and the threshold 124, and repetitive descriptions thereof are omitted here.

In an embodiment, the threshold may be determined based on at least one of the following: buffer status of the terminal device, or radio condition of the terminal device. The more details have been described in the above descriptions with respect to at least the operation 122 and the threshold 124, and repetitive descriptions thereof are omitted here.

In an embodiment, the example method 300 may further include an operation of receiving from the target network device, a mapping relationship between a plurality of candidate thresholds and at least one of the following: buffer statuses or radio conditions of a terminal device, and wherein the threshold may be determined from the plurality of candidate thresholds further based on the mapping relationship. The more details have been described in the above descriptions with respect to at least the operation 122 and the mapping relationship 134, and repetitive descriptions thereof are omitted here.

In an embodiment, the example method 300 may further include an operation of receiving from the target network device, a threshold indicated by the target network device, and wherein the threshold for the terminal device may be determined according to the threshold indicated by the target network device. The more details have been described in the above descriptions with respect to at least the operation 122 and the threshold 133, and repetitive descriptions thereof are omitted here.

In an embodiment, the example method 300 may further include an operation of transmitting to the terminal device, an indication enabling or disabling reporting of the requirement to complete the measurement via at least one of the following: a downlink RRC message, a SIB, or a downlink MAC CE. The more details have been described in the above descriptions with respect to at least the indication 126, and repetitive descriptions thereof are omitted here.

In an embodiment, the requirement to complete the measurement may comprise at least one of following: a time duration for the terminal device to acquire the measurement, or a time stamp when the terminal device expects to complete the acquisition of the measurement. The more details have been described in the above descriptions with respect to at least the requirement 116 to complete the measurement, and repetitive descriptions thereof are omitted here.

In an embodiment, the measurement may be based on at least one of the following: a GNSS, a NTN positioning signal, or a TN positioning signal. The more details have been described in the above descriptions with respect to at least the operation 112, and repetitive descriptions thereof are omitted here.

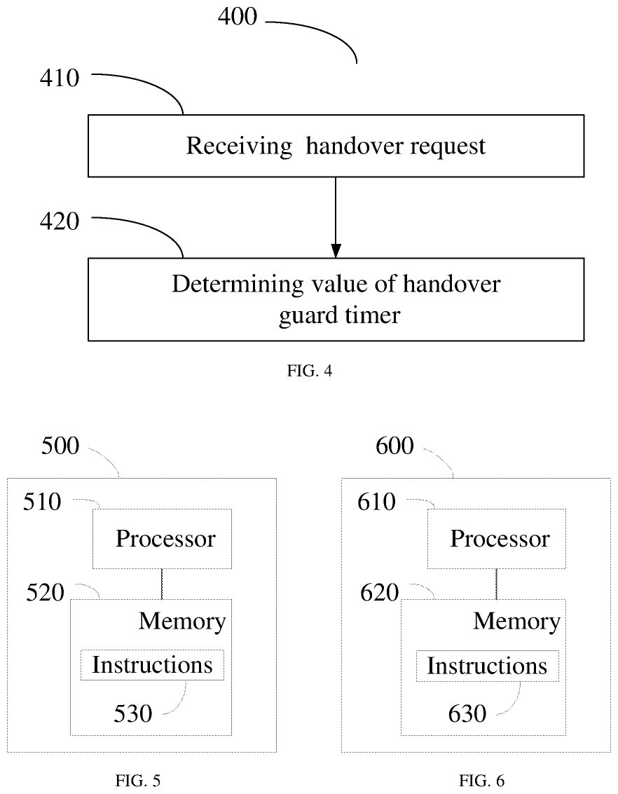

FIG. 4 shows a flow chart illustrating an example method 400 for handover according to the example embodiments of the present disclosure. The example method 400 may be performed for example at a network device such as the target network device 130 for a handover of a terminal device such as the UE 110.

Referring to the FIG. 4, the example method 400 may include an operation 410 of receiving from a source network device for the handover, a handover request comprising a requirement to complete a measurement for at least location information; and an operation 420 of determining a value of a guard timer for the handover based on the requirement to complete the measurement.

Details of the operation 410 have been described in the above descriptions with respect to at least the handover request 128 and the requirement 116 to complete the measurement, and repetitive descriptions thereof are omitted here.

Details of the operation 420 have been described in the above descriptions with respect to at least the operation 136, and repetitive descriptions thereof are omitted here.

In an embodiment, the requirement to complete the measurement may comprise at least one of following: a time duration for the terminal device to acquire the measurement, or a time stamp when the terminal device expects to complete the acquisition of the measurement. The more details have been described in the above descriptions with respect to at least the requirement 116 to complete the measurement, and repetitive descriptions thereof are omitted here.

In an embodiment, the example method 400 may further include an operation of reserving resources for the handover of the terminal device, after the time duration timing from receiving the handover request or after the time stamp when the terminal device expects to complete the acquisition of the measurement. The more details have been described in the above descriptions with respect to at least the operation 138, and repetitive descriptions thereof are omitted here.

In an embodiment, the example method 400 may further include an operation of determining at least one of the following: a threshold for the terminal device to determine the measurement is to be required in a case where a remaining measurement validity duration obtained from a preceding measurement acquisition is less than the threshold, or a mapping relationship between a plurality of candidate thresholds and at least one of the following: buffer statuses or radio conditions of a terminal device; and an operation of transmitting to the source network device, at least one of the following: the threshold or the mapping relationship. The more details have been described in the above descriptions with respect to at least the operation 132, the threshold 133, and the mapping relationship 134, and repetitive descriptions thereof are omitted here.

In an embodiment, the measurement may be based on at least one of the following: a GNSS, a NTN positioning signal, or a TN positioning signal. The more details have been described in the above descriptions with respect to at least the operation 112, and repetitive descriptions thereof are omitted here.

FIG. 5 shows a block diagram illustrating an example device 500 for handover according to the example embodiments of the present disclosure. The device, for example, may be at least part of a terminal device such as the UE 110 in the above examples.

As shown in the FIG. 5, the example device 500 may include at least one processor 510 and at least one memory 520 that may store instructions 530. The instructions 530, when executed by the at least one processor 510, may cause the device 500 at least to perform the example method 200 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example device 500 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 500.

FIG. 6 shows a block diagram illustrating an example device 600 for handover according to the example embodiments of the present disclosure. The device, for example, may be at least part of a network device such as the source network device 120 for a handover of a terminal device such as the UE 110 in the above examples.

As shown in the FIG. 6, the example device 600 may include at least one processor 610 and at least one memory 620 that may store instructions 630. The instructions 630, when executed by the at least one processor 610, may cause the device 600 at least to perform the example method 300 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the source network device 120 is not limited to the above example device 600.

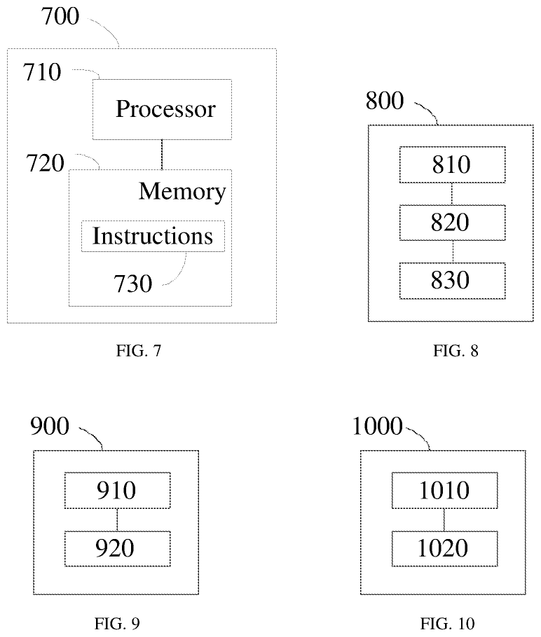

FIG. 7 shows a block diagram illustrating an example device 700 for handover according to the example embodiments of the present disclosure. The device, for example, may be at least part of a network device such as the target network device 130 for a handover of a terminal device such as the UE 110 in the above examples.

As shown in the FIG. 7, the example device 700 may include at least one processor 710 and at least one memory 720 that may store instructions 730. The instructions 730, when executed by the at least one processor 710, may cause the device 700 at least to perform the example method 400 described above.

In various example embodiments, the at least one processor 710 in the example device 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example device 700 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 720 may include, but are not limited to, an electric, a magnetic, an optical, an electromagnetic, an infrared, or a semiconductor system, apparatus, or device or any combination of the above.

Further, in various example embodiments, the example device 700 may also include at least one other circuitry, element, and interface, for example at least one I/O interface, at least one antenna element, and the like.

In various example embodiments, the circuitries, parts, elements, and interfaces in the example device 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the target network device 130 is not limited to the above example device 700.

FIG. 8 shows a block diagram illustrating an example apparatus 800 for handover according to the example embodiments of the present disclosure. The apparatus, for example, may be at least part of a terminal device such as the UE 110 in the above examples.

As shown in FIG. 8, the example apparatus 800 may include means 810 for performing the operation 210 of the example method 200, means 820 for performing the operation 220 of the example method 200, and means 830 for performing the operation 230 of the example method 200. In one or more another example embodiments, at least one I/O interface, at least one antenna element, and the like may also be included in the example apparatus 800.

In an embodiment, the example apparatus 800 may further include means for performing an operation of reporting to the source network device, the requirement to complete the measurement in a case where the measurement is determined to be unrequired, and wherein the requirement to complete the measurement may indicate that the measurement is to be unrequired.

In an embodiment, the example apparatus 800 may further include means for performing an operation of refraining from reporting to the source network device, the requirement to complete the measurement in a case where the measurement is determined to be unrequired.

In an embodiment, the measurement may be determined to be required in a case where a remaining measurement validity duration obtained from a preceding measurement acquisition of the terminal device is less than a threshold.

In an embodiment, the threshold may be predefined or received from the source network device.

In an embodiment, the measurement may be based on at least one of the following: a GNSS, a NTN positioning signal, or a TN positioning signal.

In an embodiment, the requirement to complete the measurement based on the GNSS may be determined based on at least one of the following: quality of a GNSS signal of the terminal device, positioning capability of the terminal device, or availability of ephemeris information of the terminal device for measured GNSS satellites.

In an embodiment, the quality of the GNSS signal comprises carrier-to-noise of the GNSS signal.

In an embodiment, the requirement to complete the measurement may be reported via at least one of the following: a measurement report triggered by a mobility event, a measurement report triggered by the requirement to complete the measurement, an uplink RRC message, or an uplink MAC CE.

In an embodiment, the example apparatus 800 may further include means for performing an operation of receiving from the source network device, an indication enabling or disabling reporting of the requirement to complete the measurement; and means for performing an operation of refraining from reporting the requirement to complete the measurement in a case where the indication disables reporting of the requirement to complete the measurement.

In an embodiment, the requirement to complete the measurement comprises at least one of following: a time duration for acquiring the measurement, or a time stamp when the terminal device expects to complete the acquisition of the measurement.

In some example embodiments, examples of means in the example apparatus 800 may include circuitries. For example, an example of means 810 may include a circuitry configured to perform the operation 210 of the example method 200, an example of means 820 may include a circuitry configured to perform the operation 220 of the example method 200, and an example of means 830 may include a circuitry configured to perform the operation 230 of the example method 200.

The example apparatus 800 may further include means comprising circuitry configured to perform the example method 200. In some example embodiments, examples of means may also include software modules and any other suitable function entities.

FIG. 9 shows a block diagram illustrating an example apparatus 900 for handover according to the example embodiments of the present disclosure. The apparatus, for example, may be at least part of a network device such as the source network device 120 for a handover of a terminal device such as the UE 110 in the above examples.

As shown in FIG. 9, the example apparatus 900 may include means 910 for performing the operation 310 of the example method 300, and means 920 for performing the operation 320 of the example method 300. In one or more another example embodiments, at least one I/O interface, at least one antenna element, and the like may also be included in the example apparatus 900.

In an embodiment, the example apparatus 900 may further include means for performing an operation of determining a threshold for the terminal device to determine the measurement is to be required in a case where a remaining measurement validity duration obtained from a preceding measurement acquisition is less than the threshold; and means for performing an operation of transmitting the threshold to the terminal device.

In an embodiment, the threshold may be determined based on at least one of the following: buffer status of the terminal device, or radio condition of the terminal device.

In an embodiment, the example apparatus 900 may further include means for performing an operation of receiving from the target network device, a mapping relationship between a plurality of candidate thresholds and at least one of the following: buffer statuses or radio conditions of a terminal device, and wherein the threshold may be determined from the plurality of candidate thresholds further based on the mapping relationship.

In an embodiment, the example apparatus 900 may further include means for performing an operation of receiving from the target network device, a threshold indicated by the target network device, and wherein the threshold for the terminal device may be determined according to the threshold indicated by the target network device.

In an embodiment, the example apparatus 900 may further include means for performing an operation of transmitting to the terminal device, an indication enabling or disabling reporting of the requirement to complete the measurement via at least one of the following: a downlink RRC message, a SIB, or a downlink MAC CE.

In an embodiment, the requirement to complete the measurement may comprise at least one of following: a time duration for the terminal device to acquire the measurement, or a time stamp when the terminal device expects to complete the acquisition of the measurement.

In an embodiment, the measurement may be based on at least one of the following: a GNSS, a NTN positioning signal, or a TN positioning signal.

In some example embodiments, examples of means in the example apparatus 900 may include circuitries. For example, an example of means 910 may include a circuitry configured to perform the operation 310 of the example method 300, and an example of means 920 may include a circuitry configured to perform the operation 320 of the example method 300.

The example apparatus 900 may further include means comprising circuitry configured to perform the example method 300. In some example embodiments, examples of means may also include software modules and any other suitable function entities.

FIG. 10 shows a block diagram illustrating an example apparatus 1000 for handover according to the example embodiments of the present disclosure. The apparatus, for example, may be at least part of a network device such as the target network device 130 for a handover of a terminal device such as the UE 110 in the above examples.

As shown in FIG. 10, the example apparatus 1000 may include means 1010 for performing the operation 410 of the example method 400, and means 1020 for performing the operation 420 of the example method 400. In one or more another example embodiments, at least one I/O interface, at least one antenna element, and the like may also be included in the example apparatus 1000.

In an embodiment, the requirement to complete the measurement may comprise at least one of following: a time duration for the terminal device to acquire the measurement, or a time stamp when the terminal device expects to complete the acquisition of the measurement.

In an embodiment, the example apparatus 1000 may further include means for performing an operation of reserving resources for the handover of the terminal device, after the time duration timing from receiving the handover request or after the time stamp when the terminal device expects to complete the acquisition of the measurement.

In an embodiment, the example apparatus 1000 may further include means for performing an operation of determining at least one of the following: a threshold for the terminal device to determine the measurement is to be required in a case where a remaining measurement validity duration obtained from a preceding measurement acquisition is less than the threshold, or a mapping relationship between a plurality of candidate thresholds and at least one of the following: buffer statuses or radio conditions of a terminal device; and means for performing an operation of transmitting to the source network device, at least one of the following: the threshold or the mapping relationship.

In an embodiment, the measurement may be based on at least one of the following: a GNSS, a NTN positioning signal, or a TN positioning signal.

In some example embodiments, examples of means in the example apparatus 1000 may include circuitries. For example, an example of means 1010 may include a circuitry configured to perform the operation 410 of the example method 400, and an example of means 1020 may include a circuitry configured to perform the operation 420 of the example method 400.

The example apparatus 1000 may further include means comprising circuitry configured to perform the example method 400. In some example embodiments, examples of means may also include software modules and any other suitable function entities.

The example embodiments of the present disclosure also provide a computer readable medium comprising program instructions that, when executed by a terminal device such as the UE 110 in the above examples, may cause the terminal device at least to perform: determining a measurement for at least location information is to be required or unrequired during a handover from a source network device to a target network device; determining a requirement to complete the measurement; and reporting to the source network device, the requirement to complete the measurement in a case where the measurement is determined to be required.

In an embodiment, the computer readable medium may further include instructions that, when executed by the terminal device, may cause the terminal device to further perform: reporting to the source network device, the requirement to complete the measurement in a case where the measurement is determined to be unrequired, and wherein the requirement to complete the measurement may indicate that the measurement is to be unrequired.

In an embodiment, the computer readable medium may further include instructions that, when executed by the terminal device, may cause the terminal device to further perform: refraining from reporting to the source network device, the requirement to complete the measurement in a case where the measurement is determined to be unrequired.

In an embodiment, the measurement may be determined to be required in a case where a remaining measurement validity duration obtained from a preceding measurement acquisition of the terminal device is less than a threshold.

In an embodiment, the threshold may be predefined or received from the source network device.

In an embodiment, the measurement may be based on at least one of the following: a GNSS, a NTN positioning signal, or a TN positioning signal.

In an embodiment, the requirement to complete the measurement based on the GNSS may be determined based on at least one of the following: quality of a GNSS signal of the terminal device, positioning capability of the terminal device, or availability of ephemeris information of the terminal device for measured GNSS satellites.

In an embodiment, the quality of the GNSS signal comprises carrier-to-noise of the GNSS signal.

In an embodiment, the requirement to complete the measurement may be reported via at least one of the following: a measurement report triggered by a mobility event, a measurement report triggered by the requirement to complete the measurement, an uplink RRC message, or an uplink MAC CE.

In an embodiment, the computer readable medium may further include instructions that, when executed by the terminal device, may cause the terminal device to further perform: receiving from the source network device, an indication enabling or disabling reporting of the requirement to complete the measurement; and refraining from reporting the requirement to complete the measurement in a case where the indication disables reporting of the requirement to complete the measurement.

In an embodiment, the requirement to complete the measurement comprises at least one of following: a time duration for acquiring the measurement, or a time stamp when the terminal device expects to complete the acquisition of the measurement.

The example embodiments of the present disclosure also provide a computer readable medium comprising program instructions that, when executed by a network device such as the source network device 120 for a handover of a terminal device such as the UE 110 in the above examples, may cause the network device at least to perform: receiving from the terminal device, a requirement to complete a measurement for at least location information; and transmitting to a target network device for the handover, a handover request comprising the requirement to complete the measurement.

In an embodiment, the computer readable medium may further include instructions that, when executed by the network device, may cause the network device to further perform: determining a threshold for the terminal device to determine the measurement is to be required in a case where a remaining measurement validity duration obtained from a preceding measurement acquisition is less than the threshold; and transmitting the threshold to the terminal device.

In an embodiment, the threshold may be determined based on at least one of the following: buffer status of the terminal device, or radio condition of the terminal device.

In an embodiment, the computer readable medium may further include instructions that, when executed by the network device, may cause the network device to further perform: receiving from the target network device, a mapping relationship between a plurality of candidate thresholds and at least one of the following: buffer statuses or radio conditions of a terminal device, and wherein the threshold may be determined from the plurality of candidate thresholds further based on the mapping relationship.

In an embodiment, the computer readable medium may further include instructions that, when executed by the network device, may cause the network device to further perform: receiving from the target network device, a threshold indicated by the target network device, and wherein the threshold for the terminal device may be determined according to the threshold indicated by the target network device.

In an embodiment, the computer readable medium may further include instructions that, when executed by the network device, may cause the network device to further perform: transmitting to the terminal device, an indication enabling or disabling reporting of the requirement to complete the measurement via at least one of the following: a downlink RRC message, a SIB, or a downlink MAC CE.

In an embodiment, the requirement to complete the measurement may comprise at least one of following: a time duration for the terminal device to acquire the measurement, or a time stamp when the terminal device expects to complete the acquisition of the measurement.

In an embodiment, the measurement may be based on at least one of the following: a GNSS, a NTN positioning signal, or a TN positioning signal.

The example embodiments of the present disclosure also provide a computer readable medium comprising program instructions that, when executed by a network device such as the target network device 130 for a handover of a terminal device such as the UE 110 in the above examples, may cause the network device at least to perform: receiving from a source network device for the handover, a handover request comprising a requirement to complete a measurement for at least location information; and determining a value of a guard timer for the handover based on the requirement to complete the measurement.

In an embodiment, the requirement to complete the measurement may comprise at least one of following: a time duration for the terminal device to acquire the measurement, or a time stamp when the terminal device expects to complete the acquisition of the measurement.

In an embodiment, the computer readable medium may further include instructions that, when executed by the network device, may cause the network device to further perform: reserving resources for the handover of the terminal device, after the time duration timing from receiving the handover request or after the time stamp when the terminal device expects to complete the acquisition of the measurement.

In an embodiment, the computer readable medium may further include instructions that, when executed by the network device, may cause the network device to further perform: determining at least one of the following: a threshold for the terminal device to determine the measurement is to be required in a case where a remaining measurement validity duration obtained from a preceding measurement acquisition is less than the threshold, or a mapping relationship between a plurality of candidate thresholds and at least one of the following: buffer statuses or radio conditions of a terminal device; and transmitting to the source network device, at least one of the following: the threshold or the mapping relationship.

In an embodiment, the measurement may be based on at least one of the following: a GNSS, a NTN positioning signal, or a TN positioning signal.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
3GPP 3rd Generation Partnership Project
ACK acknowledgment
BS base station
CFRA contention free random access
eMTC enhanced machine type communication
GNSS global navigation satellite system
GPS global positioning system
ID identifier
IoT internet of things
MAC CE medium access control control element
NTN non-terrestrial network
PUSCH physical uplink shared channel
RACH random access channel
RRC radio resource control
SIB system information block
TA timing advance
TN terrestrial network
UE user equipment

1-60. (canceled)

61. A terminal device, comprising:
at least one processor; and
at least one memory storing instructions that, when executed by the at least one processor, cause the terminal device at least to perform:
determining a measurement for at least location information is to be required or unrequired during a handover from a source network device to a target network device; determining a requirement to complete the measurement; and
reporting to the source network device, the requirement to complete the measurement in a case where the measurement is determined to be required.

62. The terminal device of claim 61, wherein the instructions, when executed by the at least one processor, cause the terminal device to further perform:
reporting to the source network device, the requirement to complete the measurement in a case where the measurement is determined to be unrequired, and
the requirement to complete the measurement indicates that the measurement is to be unrequired.

63. The terminal device of claim 61, wherein the instructions, when executed by the at least one processor, cause the terminal device to further perform:
refraining from reporting to the source network device, the requirement to complete the measurement in a case where the measurement is determined to be unrequired.

64. The terminal device of claim 61, wherein the measurement is determined to be required in a case where a remaining measurement validity duration obtained from a preceding measurement acquisition of the terminal device is less than a threshold.

65. The terminal device of claim 64, wherein the threshold is predefined or received from the source network device.

66. The terminal device of claim 61, wherein the measurement is based on at least one of the following: a global navigation satellite system, a non-terrestrial network positioning signal, or a terrestrial network positioning signal.

67. The terminal device of claim 66, wherein the requirement to complete the measurement based on the global navigation satellite system is determined based on at least one of the following:
quality of a global navigation satellite system signal of the terminal device,
positioning capability of the terminal device, or
availability of ephemeris information of the terminal device for measured global navigation satellite system satellites.

68. The terminal device of claim 67, wherein the quality of the global navigation satellite system signal comprises carrier-to-noise of the global navigation satellite system signal.

69. The terminal device of claim 61, wherein the requirement to complete the measurement is reported via at least one of the following:
a measurement report triggered by a mobility event,
a measurement report triggered by the requirement to complete the measurement,
an uplink radio resource control message, or
an uplink medium access control control element.

70. The terminal device of claim 61, wherein the instructions, when executed by the at least one processor, cause the terminal device to further perform:
receiving from the source network device, an indication enabling or disabling reporting of the requirement to complete the measurement; and
refraining from reporting the requirement to complete the measurement in a case where the indication disables reporting of the requirement to complete the measurement.

71. The terminal device of claim 61, wherein the requirement to complete the measurement comprises at least one of following:
a time duration for acquiring the measurement, or
a time stamp when the terminal device expects to complete the acquisition of the measurement.

72. A method performed by a terminal device, comprising:
determining a measurement for at least location information is to be required or unrequired during a handover from a source network device to a target network device;
determining a requirement to complete the measurement; and
reporting to the source network device, the requirement to complete the measurement in a case where the measurement is determined to be required.

73. An apparatus as a terminal device, comprising:
means for determining a measurement for at least location information is to be required or unrequired during a handover from a source network device to a target network device;
means for determining a requirement to complete the measurement; and
means for reporting to the source network device, the requirement to complete the measurement in a case where the measurement is determined to be required.

74. The method of claim 73, wherein the measurement is determined to be required in a case where a remaining measurement validity duration obtained from a preceding measurement acquisition of the terminal device is less than a threshold.

75. The method of claim 73, wherein the threshold is predefined or received from the source network device.

76. The method of claim 73, wherein the measurement is based on at least one of the following: a global navigation satellite system, a non-terrestrial network positioning signal, or a terrestrial network positioning signal.

77. The method of claim 76, wherein the requirement to complete the measurement based on the global navigation satellite system is determined based on at least one of the following:
quality of a global navigation satellite system signal of the terminal device,
positioning capability of the terminal device, or
availability of ephemeris information of the terminal device for measured global navigation satellite system satellites.

78. The method of claim 73, wherein the requirement to complete the measurement is reported via at least one of the following:
a measurement report triggered by a mobility event,
a measurement report triggered by the requirement to complete the measurement,
an uplink radio resource control message, or
an uplink medium access control control element.

79. The method of claim 73, further comprising:
receiving from the source network device, an indication enabling or disabling reporting of the requirement to complete the measurement; and
refraining from reporting the requirement to complete the measurement in a case where the indication disables reporting of the requirement to complete the measurement.

80. The method of claim 73, wherein the requirement to complete the measurement comprises at least one of following:
a time duration for acquiring the measurement, or
a time stamp when the terminal device expects to complete the acquisition of the measurement.
